(19) United States
(12) Patent Application Publication
(10) Pub. No.: US 2002/0092017 A1
(43) Pub. Date: Jul. 11, 2002

(54) Systems and methods for replacing television signals

(75) Inventors: Brian L. Klosterman, Pleasanton, CA (US); Douglas B. Macrae, Weston, MA (US)

Correspondence Address: CHRISTIE, PARKER & HALE, LLP, 350 WEST COLORADO BOULEVARD, SUITE 500, PASADENA, CA, 91105, US

(73) Assignee: StarSight Telecast, Inc.

(21) Appl. No.: 09/940,107

(22) Filed: Aug. 27, 2001

Related U.S. Application Data
(63) Continuation of application No. 09/354,762, filed on Jul. 29, 1999.
Application No. 09/354,762 is a continuation of application No. PCT/US98/17980, filed on Aug. 27, 1998.
(60) Provisional application No. 60/057,089, filed on Aug. 27, 1997.

(51) Int. Cl. H04N 7/025

(52) U.S. Cl. 725/35; 725/36; 725/42; 725/46

(57) ABSTRACT

The present invention provides methods and systems to substitute alternative video and/or audio signals and/or graphics and/or text to be displayed on the viewer's television display monitor for the video and/or audio signals that would otherwise be displayed according to the channel to which the viewer has tuned the television set. One aspect of the present invention provides methods and systems to replace and/or modify the advertisements that can be seen and heard by the television viewer.

### CROSS-REFERENCE TO RELATED APPLICATIONS

This application is a continuation of PCT International Application No. PCT/US98/17980, which claims priority of U.S. Provisional application No. 60/057,089, the disclosures of which are hereby incorporated by reference.

### FIELD OF THE INVENTION

The present invention relates generally to television systems, and more particularly, to the interception of television programming signals tuned by a television and the replacement or overlay of said tuned television programming signals with alternative video and/or audio programming and/or with graphics and/or text.

### BACKGROUND OF THE INVENTION

Historically, television viewers have controlled the tuning of the television and have consequently controlled the video display and audio sound of the television signal presented on the monitor and over the speakers of the viewer's television set. Early television sets were manually tunable; later, television viewers began to use infra-red remote control devices to change the channel to which the television was tuned.

In the viewer-controlled-tuning environment, television programming is typically presented to the viewer over a commercial channel which interrupts the television program with paid-for advertisements. Sponsors pay a particular network or a particular channel to insert advertisements at scheduled times during the delivery of a particular television program. For instance, a fast-food hamburger restaurant chain might pay the FOX network a large sum of money to air a commercial advertisement for a ketchup-dripping hamburger for 30 seconds at a specified time during the nationwide broadcast of the SuperBowl. Typically, during a commercial interruption to a televised program, multiple commercial advertisements are shown, back-to-back.

In the viewer-controlled-tuning environment, if the television viewer tunes the viewer's television to the channel that delivers FOX network programs to the viewer's television set, then the television viewer's television display monitor displays the SuperBowl game during the time scheduled for the airing of that game. During the time that the FOX network transmits coverage of the SuperBowl game event, the FOX network schedules interruptions in the delivery of the program for commercial advertisements. During the scheduled advertisements, if the viewer does not change channels, then the viewer's television set displays the scheduled advertisements on the viewer's television.

Many viewers do not want to watch the particular advertisements that are shown during the scheduled commercial interruptions. Such viewers might change channels, a process often referred to as “channel surfing,” during the commercial break. The channel surfing viewer must guess how long the commercial break will last, so that the viewer can finally change channels back to the FOX network in time to watch the continuation of the SuperBowl game.

Historically, television sets were “dumb” terminals that, when tuned to a particular channel, displayed on the display monitor the visual representation of the analog television signals tuned by the said television tuner. In contrast with older “dumb” television sets, many modern television sets are equipped with sophisticated and powerful programmable microprocessors and provide significant Random Access Memory (“RAM”) and Read Only Memory (“ROM”). Increasingly, modern microprocessor/RAM/ROM equipped television sets are programmed with an Electronic Program Guide (“EPG”).

As an alternative to channel surfing during commercial breaks, some viewers activate the EPG to view the schedule of upcoming programs on other channels. Recent innovations to Electronic Program Guides (“EPG”s) provide viewer-to-EPG interaction improvements and provide Picture-In-Guide (“PIG”) display of the television program simultaneous with the display of the EPG. International Application No. PCT/US95/11173 (International Publication No. WO 96/07270), the disclosure of which is incorporated by reference herein for all purposes, illustrates such an improvement. Further innovations to EPGs provide for multiple “windows” in the EPG display that allow the viewer to simultaneously, among other things: continue watching the currently tuned channel, navigate the programming schedule for the channels available to the viewer's television, and watch multiple additional modes of advertising. U.S. patent application Ser. No. 09/120488, Attorney Docket No. 32714/LTR/E190, the disclosure of which is incorporated by reference herein for all purposes, illustrates such improvements.

One of the many improvements disclosed in U.S. patent application Ser. No. 09/120488, Attorney Docket No. 32714/LTR/E190 is the collection of extensive information concerning a particular viewer, described there as a viewer's profile. Also described in U.S. patent application Ser. No. 09/120488, Attorney Docket No. 32714/LTR/E190 is the utilization of a viewer's profile to customize the presentation to the viewer of advertisement. In that invention, the presentation of advertising is customizable for every mode in which advertisement is presented to the viewer, including but not limited to the customization of advertising presented as part of the EPG display and the customization of advertising delivered by the television tuner.

### SUMMARY OF THE INVENTION

The present invention provides methods and systems to substitute alternative video and/or audio signals and/or graphics and/or text to be displayed on the viewer's television display monitor for the video and/or audio signals that would otherwise be displayed according to the channel to which the viewer has tuned the television set. One aspect of the present invention provides methods and systems to replace and/or modify the advertisements that can be seen and heard by the television viewer.

In one embodiment, the present invention uses an EPG as a platform with which to execute the innovations described herein. However, the invention is not EPG platform dependent. That is, for some embodiments of the present invention, it is not necessary that the viewer interact with an EPG. Furthermore, for some embodiments of the present invention, it is not necessary that the sophisticated interactive display system of an EPG be available on the viewer's television. That is, according to one aspect of the present invention, alteration of the selection and display of advertisements seen and heard by the television viewer is independent of any viewer profile information and is independent of the viewer's interactivity with, or even the existence of, an EPG.

According to one aspect of the present invention, an EPG generating system is optionally programmable to block the audio and video of the program currently being viewed when the EPG is activated.

According to another aspect of the invention, audio and/or video blocking is activated according to either selected channels or selected shows being viewed when the EPG is activated.

According to yet another aspect of the invention, a blocking bit located in either a channel table or show table entry is set remotely to control blocking audio and/or video blocking of either a selected channel or a selected show being viewed when the EPG is activated.

According to still another aspect of the invention, an advertisement or message is displayed on the EPG to replace the audio and/or video being blocked.

According to another aspect of the invention, the viewer's television is tuned, in a manner invisible to the viewer, to a second channel for a certain period of time, and is then tuned to the first channel.

### DESCRIPTION OF THE DRAWINGS

These and other features, aspects, and advantages of the present invention will become better understood with regard to the following description, appended claims, and accompanying drawings where:

FIG. 1 is a schematic diagram of the hierarchical database utilized to generate an EPG.

FIGS. 2A and 2B are schematic diagrams of the data structures in an EPG database for an EPG embodiment of the present invention.

FIG. 3 is a flow chart of one embodiment of the steps for activating audio and/or video blocking.

FIG. 4A is a schematic diagram depicting an EPG display on a television monitor wherein the EPG display overlays a portion of the real time video display of the television signal.

FIG. 4B is a schematic diagram depicting an EPG display on a television monitor wherein the EPG display overlays the entire real time video display of the television signal.

FIG. 5 is a schematic diagram depicting the Head End Channel Change aspect of the present invention.

FIG. 6 is a flow diagram of the Head End Channel Change process at the head end.

FIG. 7A is a schematic diagram of a television system with a single signal receiver/tuner.

FIG. 7B is a flow diagram of the Head End Channel Change process at the viewer's television set.

FIG. 8 is a schematic diagram of a television system with two signal receivers/tuners.

FIG. 9 is a flow diagram of one embodiment of the Television Channel Change process with the components necessary for the EPG Viewer Profile Implementation.

FIG. 10 is a graphic representation of a sample screen display of an interactive Electronic Program Guide with a Program-In-Guide Window for display of the real time video signal.

### DETAILED DESCRIPTION OF THE INVENTION

The present invention provides for the capability to alter what a television viewer watches without the viewer changing channels. One application of the present invention is to alter the advertisement that the viewer sees displayed on the viewer's television display monitor.

One scenario in which this application will prove useful is where a television network wants to target advertisements. Consider for example, a network, e.g., FOX, that is delivering nationwide real-time coverage of a major event, such as the SuperBowl. Historically, advertisers paid large sums of money for an advertisement to be delivered at a certain time during a commercial break in the SuperBowl coverage. The networks historically delivered several advertisements, typically ranging in duration from 15 seconds to 60 seconds, back-to-back during a single commercial break. In contrast to the historical, serial advertising model used by networks, the present invention enables advertisement multi-casting. That is, the present invention will provide systems and methods that will allow a network to set up multiple channels of advertising, e.g., FOX, FOX1, FOX2, etc. Each channel could provide a separate program of advertising synchronized in time to coincide with advertising delivered on the main channel, e.g., FOX. Using the present invention, the television set of an individual viewer who is watching the SuperBowl on FOX, will be automatically tuned, in a manner invisible to the viewer, to one of the multiple FOX channels during a commercial break. In one embodiment, the television set automatically tunes in a serial manner to one or more of the multiple FOX channels.

The criteria for selecting the channel to which a particular viewer's television will be tuned may consider an individual viewer's profile, or may be based on some other criteria, to be defined by the network. Some of the possible criteria used to make such selections are described further later in this application.

The present invention is not limited to a particular set of selection criteria. On the contrary, the present invention discloses that such selections are definable, using such approaches as are known in the art, as with table-driven software programs and/or database driven criteria selection. The data contained in the tables and/or databases that would drive the selection criteria may be based, as has already been mentioned, on the viewer's individual profile. However, the selection-driving tables and/or databases may also contain other types of data, such as the geographical location and corresponding time of day when the viewer will receive the television signal. Furthermore, the selection-driving criteria is not limited to automated methods.

This application repeatedly refers to “tuning” a television to a particular “channel.” In this application, the term “channel” includes, but is not limited to, such conventional methods of video and audio communication as television channels, cable channels, and satellite channels. Furthermore, the term “channel” also includes other methods of video, audio and other types of communication, including but not limited to Internet website addresses and external data sources.

The present invention may be implemented on a personal computer, a PCTV, a television connected to a set-top box, a television including a microprocessor, or other such devices. The disclosure of U.S. provisional patent application No. 60/057,089, titled “ELECTRONIC PROGRAMMING GUIDE INCLUDING AUDIO AND/OR VIDEO BLOCKING FUNCTION” is incorporated by reference here as if fully stated herein for all purposes. However, the invention is not limited to any particular hardware configuration or to any particular television system and will have increased utility as new combinations of computers and television systems are developed. For instance, the invention is not limited to conventional analog television, and applies equally to digital television and computer configurations.

A. Head End Channel Change

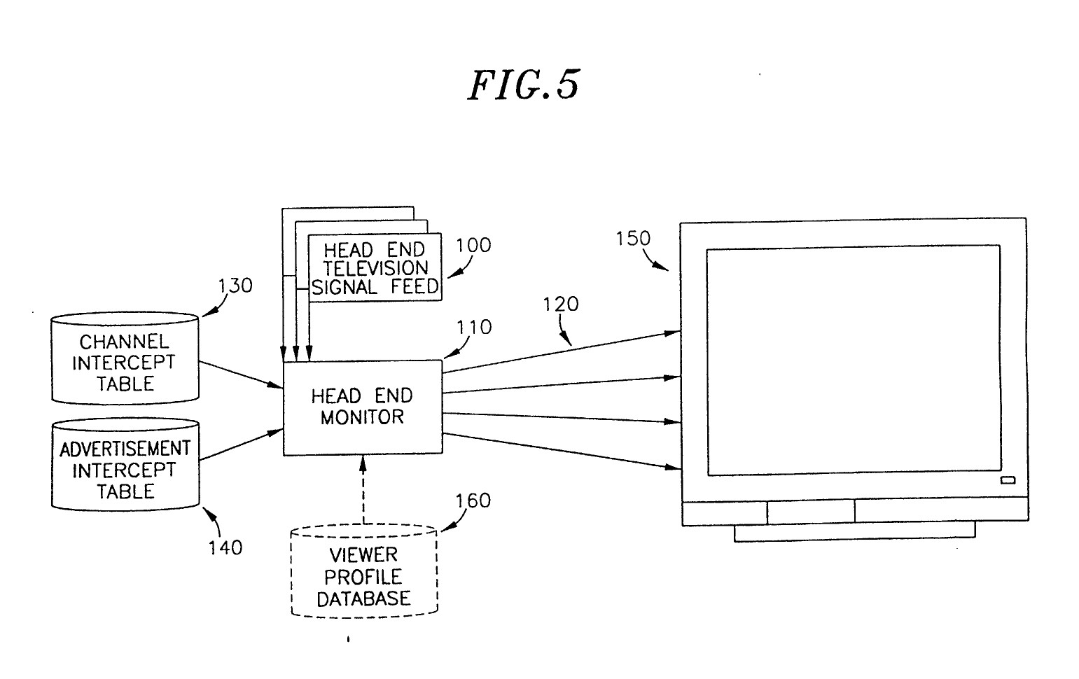

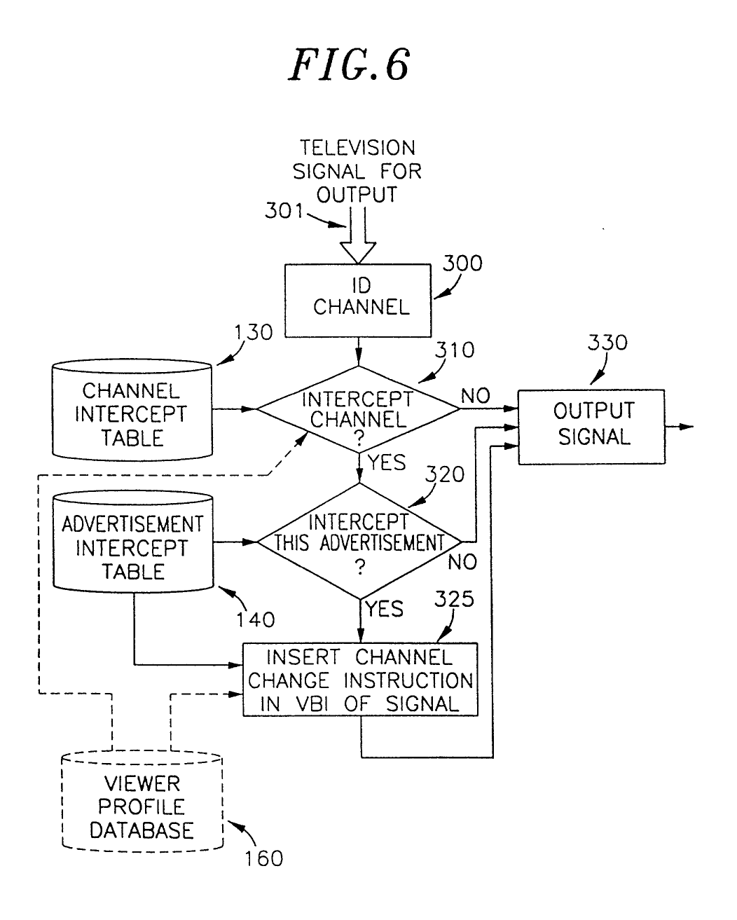

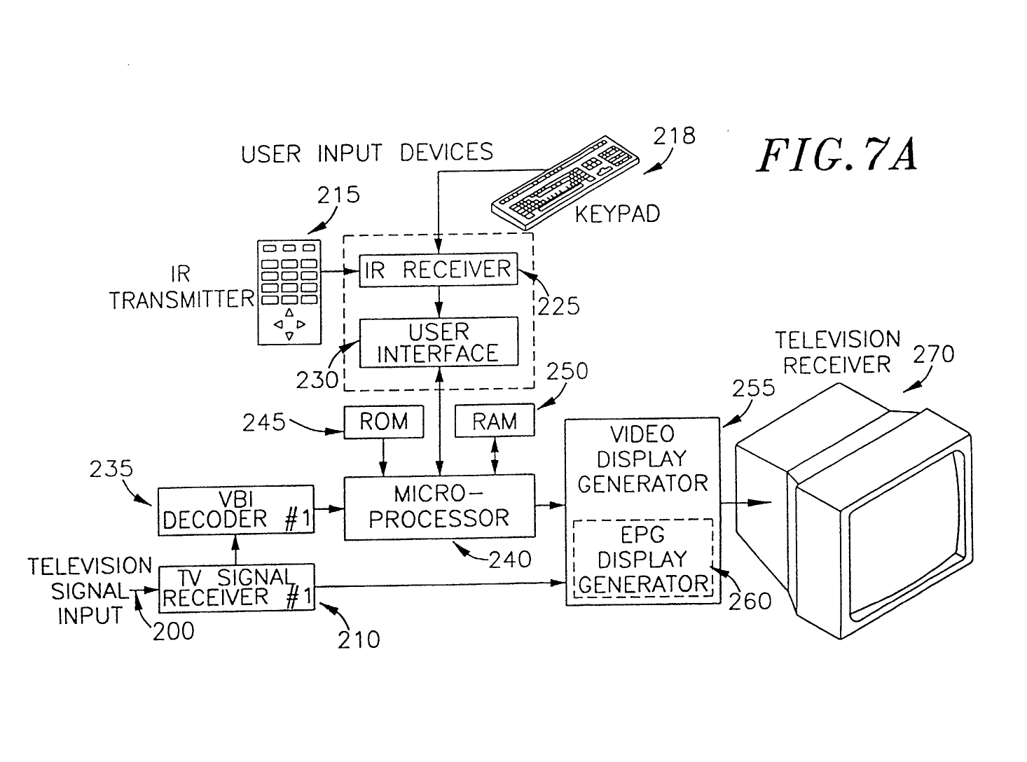

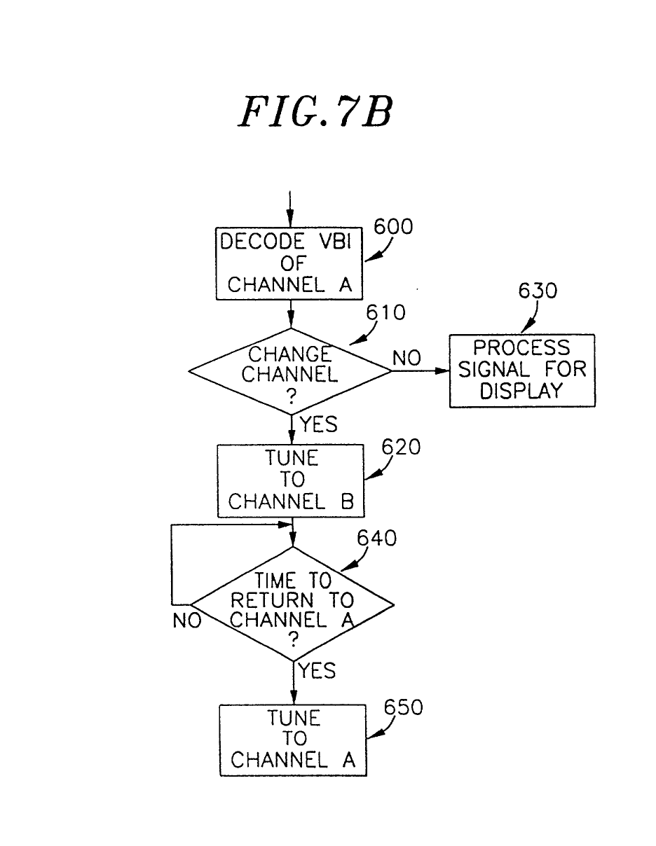

According to one aspect of the present invention, the head end delivery provider monitors the outgoing television programming signals. This aspect of the invention will be referred to as “Head End Channel Change.” FIG. 5 is a schematic diagram depicting the Head End Channel Change aspect of the present invention. FIG. 6 is a flow diagram of the Head End Channel Change process at the head end. FIG. 7A is a schematic diagram of a television system with a single signal receiver/tuner. FIG. 7B is a flow diagram of the Head End Channel Change process at the viewer's television set.

Monitoring at the head end 110 may be done electronically or manually. According to a pre-established criteria, the head end delivery provider inserts a channel change command in the vertical blanking interval (“VBI”) of one or more channels. Optionally, the channel change command is accompanied by a duration, expressed, for instance, in seconds. The pre-established criteria for the VBI channel change command insertion can be based on, for instance, a schedule of advertisements as identified in a channel, program and advertisement scheduling table. Alternatively, the head end delivery provider interrogates the outgoing signal and detects a particular event, such as, for instance, a change from television programming to commercial advertising. The channel change command instructs the receiving television set to tune to a particular channel.

In one embodiment of Head End Channel Change, the head end delivery provider monitors 110 the outgoing television programming signals of a particular channel, Channel A. The channels that are to be monitored are defined to the head end by data in a table or a database 130. The head end monitor determines whether a particular channel is to be intercepted 310. When the monitored channel begins delivering advertising, the head end provider checks a table or database 140 that contains information necessary to determine whether a particular advertisement should be intercepted 320 with a channel change command. The table and/or database 140 would contain, among other things, the channel, time, and channel change information. This collective information is sometimes referred to below as “channel and advertising intercept database information.” If the head end provider determines that the advertisement should be intercepted, then the head end provider inserts a channel change instruction in the VBI 325 that instructs the receiving television to change to a second particular channel, Channel B. That is, the timing of the insertion of the channel change command in the VBI is coincident with the beginning of an advertisement. Channel B delivers alternative advertisement and/or television programming synchronized in time with Channel A's delivery of advertising. Televisions are equipped with a microprocessor programmed to recognize the channel change command and to tune the television to the channel indicated in the VBI command.

In an alternative embodiment, the head end inserts 325 a channel change command in the VBI but does not specify the particular channel to which the television should tune. In this embodiment, the television microprocessor will determine, based on information available to the television system, including but not limited to, viewer profile information, an advertising database, and other types of information, to which channel the television should tune.

FIG. 7A is a schematic diagram of a television system with a single signal receiver/tuner. FIG. 7B is a flow diagram showing the Head End Channel Change process at the viewer's television set. The television receiver 210 receives the input television signal. The television receiver 210 includes a tuner. The television receiver sends the television signal to the VBI decoder 235 to decode the information carried in the VBI of the signal. The VBI decoder 235 sends the decoded VBI information to the microprocessor 240 for analysis.

Consider then, a particular viewer's television set that is tuned to Channel A. In the Head End Channel Change environment, when the viewer's television set receives a change channel command in the VBI of Channel A 600/610, the television system is programmed to execute the change channel command and instruct the television tuner to tune to Channel B 620. If the VBI channel change command is accompanied by a duration component, then the television is programmed to leave the television tuned to Channel B for the duration expressed in the VBI command (the “Channel B duration”) 640. At the expiration of the Channel B duration, the television is programmed to tune the television to Channel A 650. In one embodiment of this aspect of the invention (the “Manual Intervention” embodiment), if the viewer intervenes with the Head End Channel Change sequence and instructs the television to change to a particular channel, for instance, Channel C, then the television is programmed to ignore the expiration of the Channel B duration. In such a Manual Intervention embodiment, the television will remain tuned to Channel C even after the expiration of the Channel B duration. In another embodiment, the television is programmed to ignore the viewer's manual intervention, and retunes the television to Channel A at the expiration of the Channel B duration. In an alternative embodiment, the head end continues to monitor the advertisement on Channel A. When the head end determines that the advertisement is finished on Channel A, the head end inserts a channel change command in the VBI of Channel A to instruct the viewer's television to return to Channel A. In this embodiment, the television is monitoring Channel A, even though the viewer is watching Channel B.

The channel change instruction will be implemented if the viewer is watching the television in television mode. In this application, television mode refers to the operation of a television whereby the viewer is watching the television with the television display fully occupying the television's display monitor, and during a time when real-time television signals (as opposed to recorded video signals) are displayed on the television. Furthermore, the channel change instruction will also be implemented if the viewer is in the EPG mode. In this application, EPG mode refers to the operation of a television whereby the viewer has activated the EPG and some on screen display, formatted by the EPG, is apparent on the television display monitor. As mentioned above, many modern EPGs use what is know as a Picture-In-Guide (“PIG”) Window. That is, when the television is operating in the EPG mode, the television signal for the channel to which the television is tuned is displayed in a “Window,” the Picture-In-Guide Window, such as a fixed position area of the on screen display of the television monitor. FIG. 10 is a graphic representation of a sample screen display of an interactive Electronic Program Guide with a Program-In-Guide Window 12 for display of the real time video signal. Implementing a channel change instruction when the viewer is in the EPG mode in the case where the EPG provides for the television signal to continue to be displayed in the PIG Window, 12 will cause the PIG display to reflect the changed channel in the PIG Window 12.

Consider as an example that the SuperBowl is being telecast on Channel A. Channel A interrupts the televised delivery of the SuperBowl to deliver several scheduled advertisements back-to-back. The head end detects the change in the television signal to signify that an advertisement is being delivered. The head end checks the information available to it, such as the channel and advertising intercept database information described above, to determine whether the advertisement should be intercepted. If so, the head end immediately inserts an instruction in the VBI of Channel A to tune to Channel B.

In this example, a viewer is watching the SuperBowl on the viewer's television set that is tuned to Channel A. Channel A interrupts the SuperBowl program to show a beer commercial. The viewer's television is programmed to recognize and execute the VBI change channel command. When the viewer's television encounters the VBI change channel command, the viewer's television tunes to Channel B. Channel B shows a commercial for a nationally recognized brand of athletic shoes. When the commercial on Channel B is complete, the viewer's television is programmed to return to Channel A. The change of channels is invisible to the viewer.

Alternatively, when the television set tunes to Channel B, Channel B provides a mixture of commercial and non-commercial programming related to the SuperBowl, such as athlete interviews and team endorsed sports equipment. The viewer's television is programmed to tune to Channel A at the conclusion of the mixed commercial and non-commercial programming on Channel B.

B. Television Channel Chance

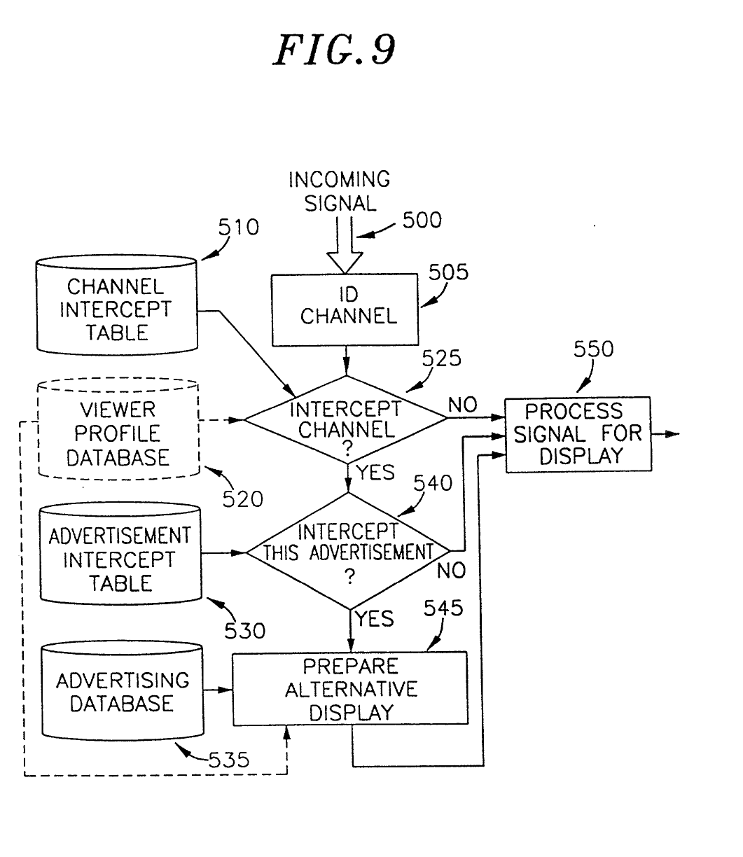

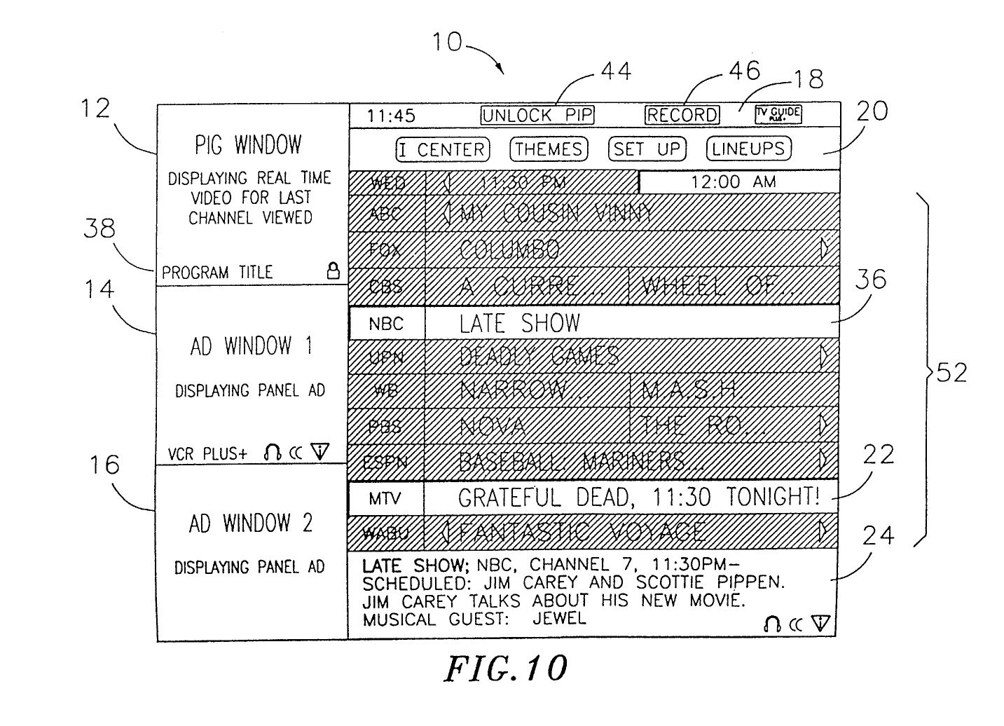

According to another aspect of the present invention, the television system is programmed to monitor the television programming signals tuned by the television. FIG. 9 is a flow diagram of one embodiment of the Television Channel Change process with the components necessary for the EPG Viewer Profile Implementation. According to a pre-established criteria, the television set instructs the television to change channels (the “Television Channel Change”). Optionally, the channel change command specifies an express duration in time. The pre-established criteria to change channels can be based on, for instance, a schedule of advertisements as identified in a channel, program and advertisement scheduling table maintained in RAM (the “advertising schedule database”) 510 and 530. In an embodiment where the advertising schedule database is maintained in RAM, the data content of the advertising schedule database is updated through some manner recognized in the art, for instance through transmission of database updates through the VBI. Alternatively, the advertising schedule database 510 and 530 may be maintained at a location addressable by the television, such as on the Internet. The advertising schedule database contains an entry for each advertisement that is to be intercepted. Each entry specifies, among other things, the channel which is scheduled to carry the advertisement to be intercepted (Channel A), the start time of the advertisement to be intercepted, the channel (Channel B) to which the television should be tuned, and, optionally, the duration of time for which the television should remain tuned to Channel B.

Alternatively, the pre-established criteria to change channels can be based on certain changes detected in the tuned television signal. For instance, the television interrogates the tuned signal and detects a particular event, such as, for instance, a change from television programming to commercial advertising. This process is similar to the process flow diagram in FIG. 7B. When the television detects such a pre-defined event, the television instructs the tuner to change channels to a particular channel. In one embodiment of the Television Channel Change, the television builds the instruction to change channels from information located in the advertising schedule database described above. In another embodiment of the Television Channel Change, the television builds the instruction to change channels from information located in the relevant Channel Data Table entry and/or Show List entry as are described in detail later in this application and from the corresponding entry in the advertising database also described in detail later in this application.

As was previously mentioned, a channel change instruction will be implemented if the viewer is watching the television in television mode. Furthermore, a channel change instruction will also be implemented if the viewer is in the EPG mode, causing the PIG display 12 to reflect the changed channel in the PIG Window 12.

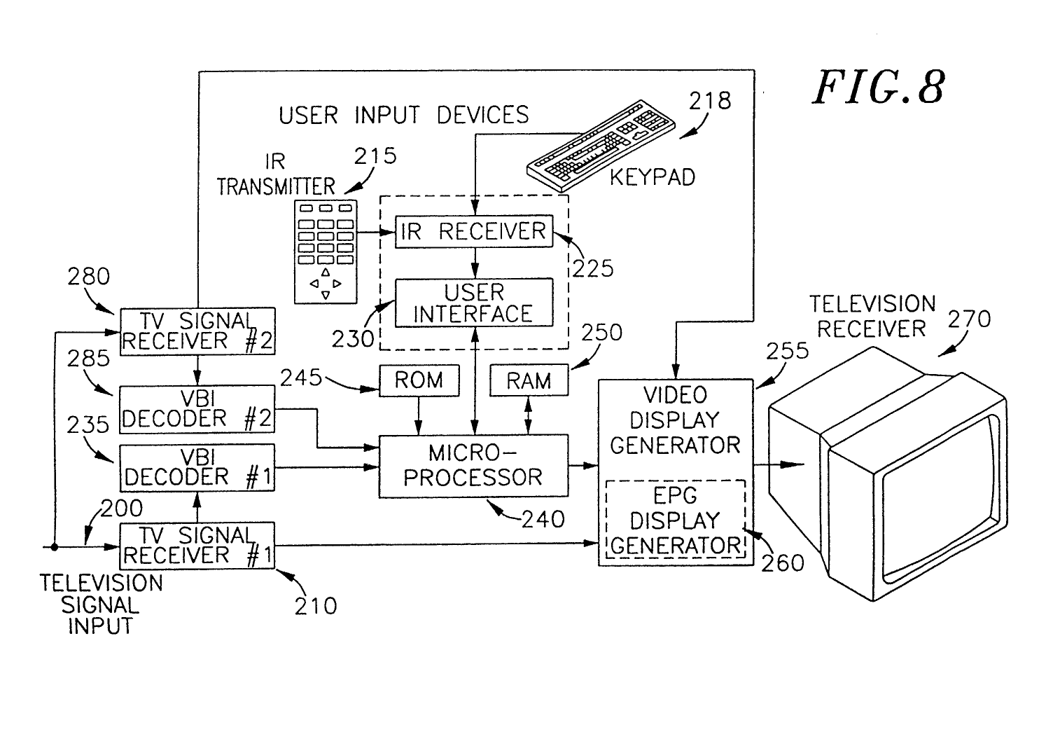

In an alternative embodiment, the television is equipped with two tuners. FIG. 8 is a schematic diagram of a television system with two signal receivers/tuners. In this embodiment, rather than maintain a duration time for each commercial to be intercepted, the television uses one tuner to tune to the Channel B; the television uses the second tuner 280 to monitor, as was previously described above in this application in connection with Head End Channel Change, the Channel A to determine when the advertisement is finished. When the second tuner 280 detects that the advertisement is finished, the second tuner 280 instructs the television to display Channel A on screen. This can be implemented in one of two ways. One way is to instruct the television to use the first tuner to tune to Channel A. The second way is to switch the control of the on screen display from the first tuner, which is tuned to Channel B, to the second tuner which is already tuned to Channel A.

C. EPG Implementation

According to another aspect of the invention, changes to the television signal that the viewer watches are only implemented if the viewer activates the EPG. This aspect of the invention is referred to as the “EPG Implementation.”

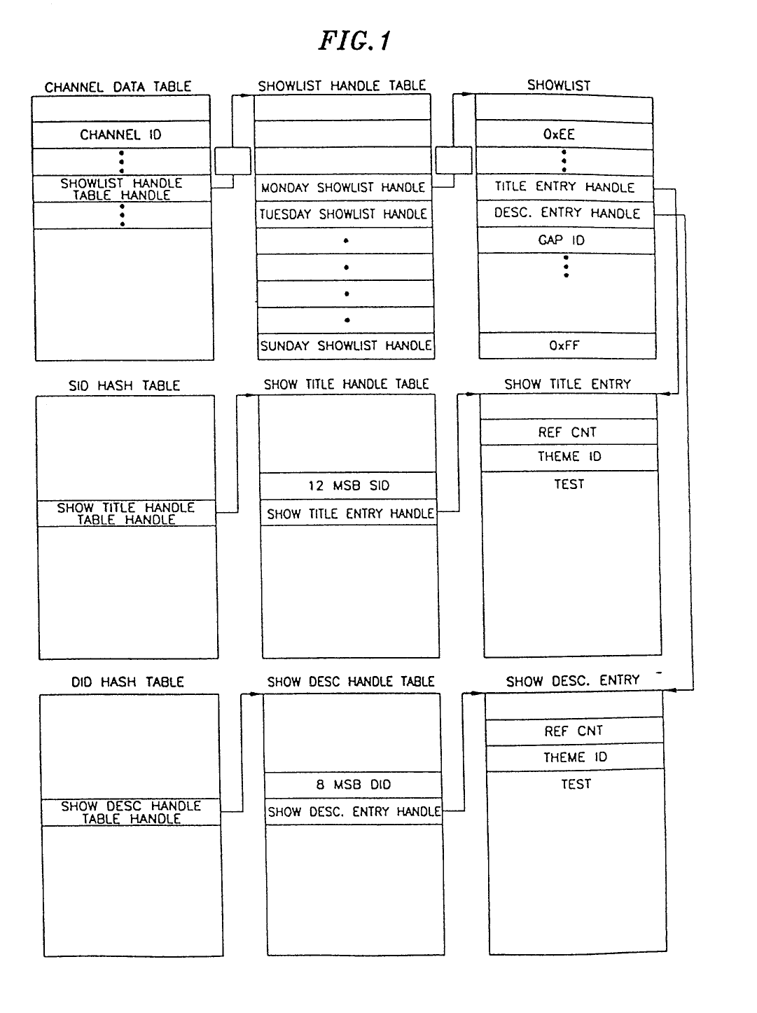

In the EPG Implementation, a Data Base Engine (“DBE”) builds a database in RAM. FIG. 1 depicts a hierarchical structure of such a database. In one embodiment, the database is structured internally as schedule data structures and theme data structures linked by handles and handle tables. Each handle is an index to a handle table which contains pointers to blocks of memory where structures of the database are stored.

In one embodiment, the hierarchy of the schedule data structures, in descending order, is:

| | |
|---|---|
| Channel Data Table: | contains subscriber unit's list of |
| | channels; |
| Show List: | contains time slots for each show |
| | scheduled to be broadcast for a |
| | channel; |
| Show Title: | contains the title text and show title |
| | attributes; |
| Show Description: | contains the show's ratings, |
| | attributes, and description text. |

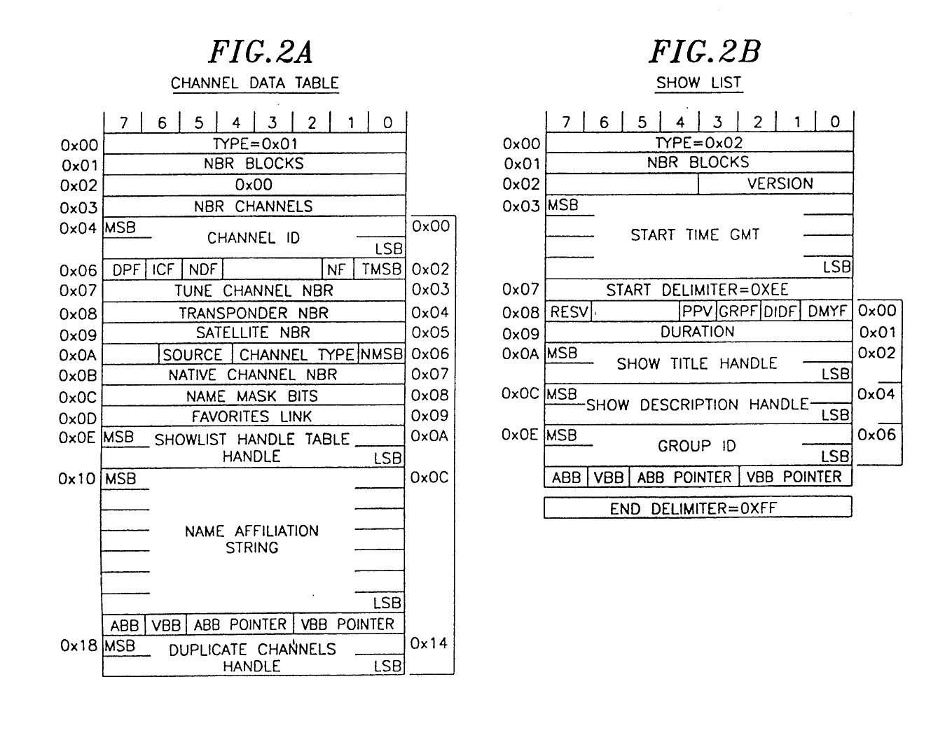

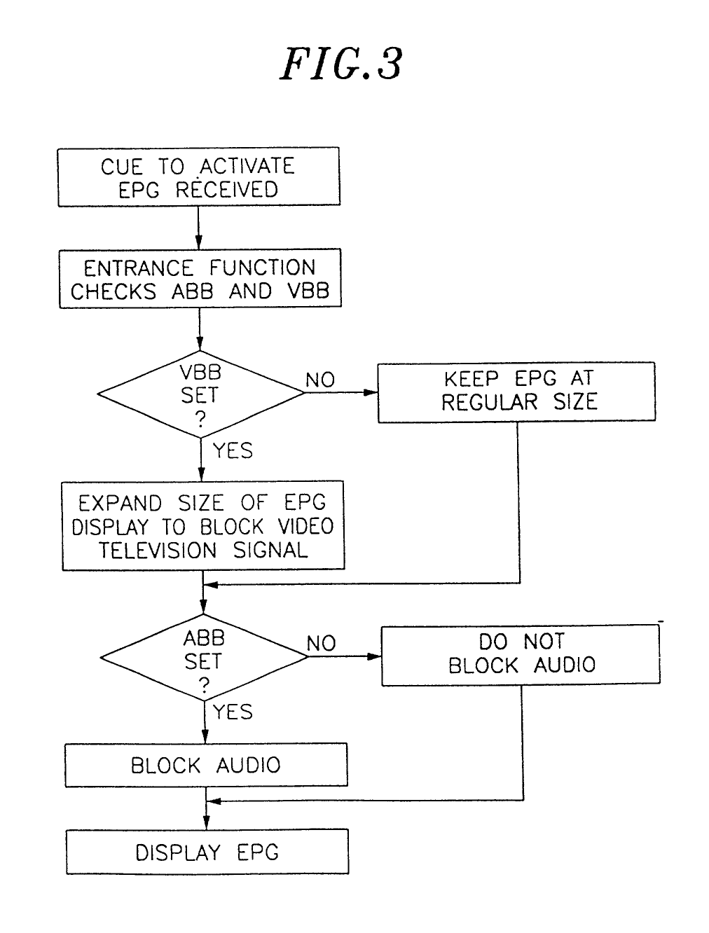

A channel data table, as depicted in FIG. 2A, is the highest level data structure in the depicted hierarchy. This table includes an entry for each channel received by the viewer's television. The entries in the channel data table are changed infrequently and are determined by the location of the subscriber unit and type of services received. Each channel data table entry includes information concerning the channel and a handle to a show list handle table for the channel. Additionally, in the EPG Implementation, the channel data table includes an audio blocking bit (“ABB”), and a video blocking bit (“VBB”) which are set by commands received by the DBE.

The next data structure in the hierarchy, as depicted in FIG. 2B, is the show list. The show list includes a start time typically being midnight GMT and 24 hours of scheduling. The channel's schedule is given by an ordered sequence of show slots, with a show slot for each show to be broadcast by a particular channel for a particular day. Each slot includes a duration, show title handle, and show description handle. Finding an entry corresponding to a given start time requires the entries to be scanned, in order, from the beginning of the show list and adding duration values. In the EPG Implementation, the show slots include an ABB and a VBB.

In one embodiment of the EPG Implementation, the ABB and VBB in both the Channel Table Entries and the Show List Entries are accompanied by additional information, including pointers to entries in the advertising database described below.

In addition to the above-described program scheduling data, one embodiment of the EPG Implementation provides for the creation and maintenance of an advertising database at the local television system. The advertising database will contain advertisements comprising video, audio, graphics and/or text components. The advertising database may also contain instructions to tune to a particular channel. The channel-tuning instructions will be used by the system to tune the television to channels which provide advertising.

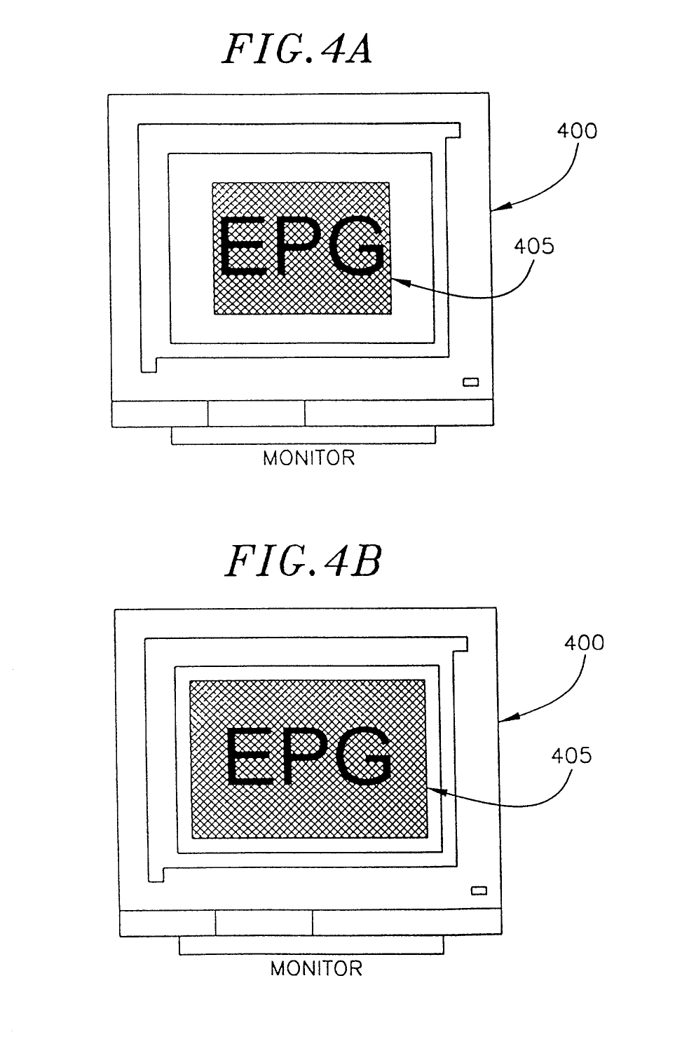

In one embodiment of the EPG Implementation, the present invention uses the audio blocking bit (“ABB”) and video blocking bit (“VBB”) in the channel ID entries in the channel data table and the show list entries in the show list data structures described above and depicted in FIGS. 2A and 2B to determine whether to block the video and/or audio signals currently tuned by the viewer's television set. FIG. 3 is a flow chart of one embodiment of the steps for activating audio and/or video blocking. The values saved in the ABB and VBB data fields will have been previously set for each channel and each show. FIG. 4A is a schematic diagram depicting an EPG display on a television monitor wherein the EPG display overlays only a portion of the real time video display of the television signal. FIG. 4B is a schematic diagram depicting an EPG display 405 on a television monitor 400 wherein the EPG display overlays (blocks) the entire real time video display of the television signal.

When the user activates the EPG, the EPG checks the VBB of the channel table entry of the channel currently tuned prior to the viewer entering the EPG. In one embodiment of the EPG Implementation, if the VBB in the channel table entry of the currently tuned channel is set “on,” then the EPG display is adjusted to completely cover the screen. That is, the show being viewed is completely blocked out.

Similarly, the ABB for the currently tuned channel is checked. If the ABB in the channel table entry of the currently tuned channel is set “on,” then the EPG blocks the audio portion of the currently tuned channel when the viewer enters the EPG. That is, if the signal provided to the television system is modulated onto channel 3/4 output, then the audio signal is not modulated onto the output signal.

If either audio and visual blocking is activated, then the above-described advertising database is accessed. In one embodiment of the EPG Implementation, the system accesses the advertising database according to a preprogrammed set of instructions that would be dependent upon criteria, including, but not limited to: the time of day; the day of the week; the type of program that the viewer was watching immediately before activating the EPG; and/or, the channel to which the viewer was tuned immediately before activating the EPG. The preprogrammed set of instructions determines the appropriate advertisement to display in the appropriate window and/or windows of the EPG display. The preprogrammed set of instructions could further utilize viewer profile characteristics to determine the appropriate advertisement to display on the viewer's television monitor.

In another embodiment of the EPG Implementation, the ABB and VBB in both the Channel Table Entries and the Show List Entries are accompanied by additional pointers to entries in the advertising database 535 described above. In this embodiment, if either the ABB or VBB are set “on,” then the system accesses the advertising database as instructed by the pointers associated with the ABB and/or VBB. The system then uses the advertising data, whether video, audio, graphics, text, or a command to tune to another channel, to present alternative advertising to the viewer, either in the PIG display window, or in some other window or display device of the EPG. Alternatively, the alternative advertising data is accessed by a link to the Internet. Alternatively, the alternative advertising data, including video, audio, graphics, and/or text, is delivered by the EPG provider from the head end, e.g., through the VBI.

D. EPG Viewer Profile Implementation

According to still another aspect of the invention, changes to the television signal that the viewer watches are only implemented if the television provides an EPG and if the EPG is programmed to customize advertising based on the collection of data known as the Viewer Profile. This aspect of the invention is referred to as the “EPG Viewer Profile Implementation.” U.S. patent application Ser. No. 09/120488, Attorney Docket No. 32714/LTR/E190, the disclosure of which is incorporated by reference herein for all purposes, discloses the collection of Viewer Profile data. The EPG Viewer Profile Implementation is not necessarily dependent upon the viewer actually activating the EPG.

In one embodiment of the EPG Viewer Profile Implementation, the television system uses Viewer Profile information 520 to customize the presentation and/or scheduling of telecast advertisements that are viewable during the real time telecast of the television program that the viewer is watching. One example is customizing an overlay message to an advertisement on a local geographic basis. For instance, the geographic location of the individual viewer is known to the television system. The broadcaster or head end can packet match on the zip code to customize the message so each zip code gets a different message, i.e., the 3 Burger Kings in the viewer's local area. In one embodiment, the customized messages can be preloaded by zip code into the memories of particular viewers' television system, as through an EPG. The preloaded messages can be transmitted by a head end during off hours and stored in the viewer's terminal for use when the advertisement runs, e.g., during a television program or in a video clip in the Ad Window 14 and/or 16. The electronic trigger to run the message can be transmitted along with the television signal in real time and can identify the messages stored in the user terminal that need to be applied.

In another embodiment of the EPG Viewer Profile Implementation, the customized messages are narrowcast, according to viewer profile information maintained at the head end, with the televised advertisement. One way to narrowcast the customized messages is to embed the customized information in the advertisement video stream. Another way is to transmit a digital “watermark” in the video stream of the advertisement.

In one embodiment of the EPG Viewer Profile Implementation, customization of real-time viewing of advertisements is achieved by providing multiple channels of advertising, by tuning the television automatically to a particular advertising channel at the time during the telecast of the television program during which an advertisement is scheduled to occur, and by then tuning the television back to the viewer's chosen television program at the conclusion of the advertisement. In the EPG Viewer Profile Implementation, the EPG determines, based on the Viewer Profile 520, to which of multiple alternative advertising channels the television should be instructed to tune.

In another embodiment, a service monitors telecasts for advertisements as they are telecast on a particular channel and, based on the viewer profile information maintained at the head end 160, inserts a change channel command in the Vertical Blanking Interval (the “VBI”) when an ad is telecast, said change channel command causing the television to tune to a particular channel. Alternatively, the head end inserts the change channel command, and the EPG at the viewer's television determines to which of multiple possible alternative advertising channels the television should be tuned according to the Viewer's Profile 520.

In this application, the term Viewer Profile includes all aspects of the viewer that can be collected by the EPG, and includes, but is not limited to, the information described as viewer profile data, viewer profile characteristics, viewer profile information, and/or viewer profile in U.S. patent application Ser. No. 09/120488, Attorney Docket No. 32714/LTR/E190, and includes as well, the “access-content” information model, the “adjacent-content” information model, and the “history of use” information model described therein.

The EPG can select advertisements from various possible locations, including but not limited to: a library of advertisements 535 stored at the viewer's terminal in RAM, that have been downloaded through the VBI, stored at the head-end, or accessible through an EPG link to the Internet/World Wide Web. The advertisements 535 may be in the form of graphics, text, video clips, audio clips, and combinations thereof. Each advertisement can be assigned theme codes, profile codes, and other selection intelligence. In one embodiment, in order to customize the advertising display, the EPG searches the library of available advertisements to locate advertisements that match criteria set by the advertisers for “access content,” “adjacent content,” “history of use,” and/or Viewer Profile information. In another embodiment, the EPG selects advertisements for display according to pre-established selection criteria.

Illustrative Embodiments

The embodiments of the invention described herein are only considered to be preferred and/or illustrative of the inventive concept; the scope of the invention is not to be restricted to such embodiments. Various and numerous other arrangements may be devised by one skilled in the art without departing from the spirit and scope of this invention. For example, the invention applies equally to digital television as it does to conventional analog television.

What is claimed is:

1. A method for substituting alternative video and/or audio signals and/or graphics and/or text to be displayed on the viewer's television display monitor in the place of the video and/or audio signals that would otherwise be displayed according to the channel to which the viewer has tuned the television set, the television set including an electronic program guide, the method comprising the steps of:
maintaining at a head end provider viewer profile data based on user interactions with the electronic program guide;
monitoring at the head end provider an outgoing television signal for a first particular channel;
identifying the point in said outgoing television signal at which said signal begins to carry advertising information;
inserting in said outgoing television signal on said first particular channel an instruction to any television that receives said television signal to change channels to a second particular channel;
receiving said television signal at a viewer's television set on said first particular channel;
recognizing said instruction at said viewer's television set to change channels;
determining whether the television set is operating in an electronic program guide mode;
tuning said viewer's television set to said second particular channel if the television set is operating in the electronic program guide mode; and
tuning said viewer's television set to said first particular channel.

2. The method of claim 1, wherein said instruction to change channels includes a duration of time and the television set is tuned to the second particular channel for said duration of time.

3. The method of claim 1, wherein the second channel is an advertisement channel providing advertisement information.

4. The method of claim 3 further comprising the step of displaying the advertisement information on a pre-determined portion of the electronic program guide.

5. A system for substituting alternative video and/or audio signals and/or graphics and/or text to be displayed on the viewer's television display monitor in the place of the video and/or audio signals that would otherwise be displayed according to the channel to which the viewer has tuned the television set, the television set including an electronic program guide, the system comprising:
means for maintaining at a head end provider viewer profile data based on user interactions with the electronic program guide;
means at the head end provider to monitor an outgoing television signal for a first particular channel;
means to identify the point in said outgoing television signal at which said signal begins to carry advertising information;
means to insert in said outgoing television signal on said first particular channel an instruction to any television that receives said television signal to change channels to a second particular channel;
means to receive said television signal on said first particular channel;
means for determining whether the television set is operating in an electronic program guide mode;
means at a viewer's television set to tune to said second particular channel if the television set is operating in the electronic program guide mode; and
means at said viewer's television set to tune to said first particular channel.

6. The system of claim 5, wherein the instruction to change channels includes a duration of time and the television set is tuned to the second particular channel for said duration of time.

7. The system of claim 5, wherein the second channel is an advertisement channel providing advertisement information.

8. The system of claim 7 further comprising means for displaying the advertisement information on a pre-determined portion of the electronic program guide.

9. A method for replacing television signals in a television system including a television set and an electronic program guide, the method comprising:
maintaining a plurality of advertisement channels, each advertisement channel providing different advertisement information;
collecting viewer profile data based on user interactions with the electronic program guide;
selecting an advertisement channel based on the collected viewer profile data;
monitoring an outgoing television signal for a particular television channel;
identifying a point in the outgoing television signal for transmitting advertisement information;
inserting in the outgoing television signal for the particular television channel an instruction to change channels;
tuning to the particular television channel;
receiving the instruction to change channels;
determining whether the television set is operating in an electronic guide mode; and
tuning to the selected advertisement channel for a duration of the advertisement carried by the selected advertisement channel if the television set is operating in the electronic guide mode.

10. The method of claim 9 further comprising collecting viewer profile data based on user interactions with the television system.

11. The method of claim 9 further comprising transmitting the collected viewer profile data to a head end provider.

12. The method of claim 9 wherein the instruction to change channels comprises an instruction to change to the selected advertisement channel.

13. The method of claim 9 further comprising:
receiving a user command to change to a specific television channel prior to the expiration of the duration of the advertisement carried by the selected advertisement channel;
tuning to the specific television channel; and
remaining tuned to the specific television channel after the expiration of the duration of the advertisement.

14. The method of claim 9 further comprising displaying the advertisement information on a pre-determined portion of the electronic program guide.

15. The method of claim 9 further comprising tuning to the particular television channel at an expiration of the duration of the advertisement.

16. A system for replacing television signals in a television system including a television set and an electronic program guide, the system comprising:
means for maintaining a plurality of advertisement channels, each advertisement channel providing different advertisement information;
means for collecting viewer profile data based on user interactions with the electronic program guide;
a head end monitor monitoring an outgoing television signal for a particular television channel and inserting an instruction to change channels at a point in the outgoing television signal where advertisement information is to be transmitted;
a television signal receiver including a tuner tuning to the particular television channel, the receiver receiving the instruction to change channels;
a microprocessor coupled to the television signal receiver, the microprocessor determining whether the television set is operating in an electronic guide mode and causing the tuner to tune to the selected advertisement channel for a duration of the advertisement carried by the selected advertisement channel if the television set is operating in the electronic guide mode.

17. The system of claim 16 further comprising means for collecting viewer profile data based on user interactions with the television system.

18. The system of claim 16 further comprising means for transmitting the collected viewer profile data to a head end provider.

19. The system of claim 16 further comprising:
a user input device for selecting a specific television channel for viewing;
wherein the microprocessor causes the tuner to tune to the specific television channel upon receipt of the user selection prior to the expiration of the duration of the advertisement carried by the selected advertisement channel and remain tuned to the specific television channel after the expiration of the duration of the advertisement.

20. The system of claim 16 wherein the microprocessor causes the advertisement carried by the selected advertisement channel to be displayed on a pre-determined portion of the electronic program guide.

21. The system of claim 16, wherein the microprocessor causes the tuner to tune to the particular television channel at an expiration of the duration of the advertisement.

22. A television system including a television set and an electronic program guide for replacing television signals, the system comprising:
means for collecting viewer profile data based on user interactions with the electronic program guide;
a television signal receiver including a tuner tuning to the particular television channel, the receiver receiving an instruction to change channels;
a memory storing advertisement schedule information for a plurality of advertisements, the information including a channel designation for each of the advertisements;
a microprocessor coupled to the memory and the television signal receiver, the microprocessor determining whether the television set is operating in an electronic guide mode, selecting an advertisement channel based on the collected viewer profile data if the television set is operating in electronic guide mode, and causing the tuner to tune to the advertisement channel for a duration of the advertisement carried by the selected advertisement channel.

23. The system of claim 22 further comprising means for collecting viewer profile data based on user interactions with the television system.

24. The system of claim 22, wherein the microprocessor causes the advertisement carried by the selected advertisement channel to be displayed on a pre-determined portion of the electronic program guide.

25. The system of claim 22, wherein the microprocessor causes the tuner to tune to tune to the particular television channel at an expiration of the duration of the advertisement.

26. A system for replacing television signals, the system comprising:
a television signal receiver including a tuner tuning to a first television channel, the receiver receiving an instruction to change channels to a second channel;
a display monitor for displaying an electronic program guide while in an electronic program guide mode;
a processor coupled to the television signal receiver and display monitor, characterized in that the processor determines whether the display monitor is displaying the electronic program guide in the electronic program guide mode, causes the tuner to tune to the second channel upon receipt of the instruction to change channels if the display monitor is displaying the electronic guide in the electronic program guide mode, and further causes the display monitor to display content carried by the second channel on a pre-determined portion of the electronic program guide.

27. A system for replacing television signals, the system comprising:
a television signal receiver including a tuner tuning to a first television channel;
a display monitor displaying contents of the first television channel;
a memory storing an indicia indicating whether contents of the first television channel displayed on the display monitor are to be replaced; and
a processor coupled to the signal receiver, display, and memory, characterized in that the processor checks the indicia to determine whether the contents of the first television channel displayed on the display monitor are to be replaced, and replaces the displayed contents with a second content if the indicia indicates that the displayed contents are to be replaced.

28. The system of claim 27, wherein the second content is an advertisement selected based on user profile information.
